(19) United States
(12) Patent Application Publication
(10) Pub. No.: US 2009/0307636 A1
(43) Pub. Date: Dec. 10, 2009

(54) SOLUTION EFFICIENCY OF GENETIC ALGORITHM APPLICATIONS

(75) Inventors: Moises Cases, Austin, TX (US); Jinwoo Choi, Austin, TX (US); Bhyrav M. Mutnury, Austin, TX (US); Caleb J. Wesley, Winston Salem, NC (US)

Correspondence Address: IBM CORPORATION (JVM), C/O LAW OFFICE OF JACK V. MUSGROVE, 2911 BRIONA WOOD LANE, CEDAR PARK, TX, 78613, US

(73) Assignee: INTERNATIONAL BUSINESS MACHINES CORPORATION, Armonk, NY (US)

(21) Appl. No.: 12/133,480

(22) Filed: Jun. 5, 2008

(51) Int. Cl. G06F 17/50; G06N 3/12

(52) U.S. Cl. 716/2; 706/13

(57) ABSTRACT

A method of optimizing a very large scale integrated circuit design takes a circuit description which includes interconnected circuit components and characteristic variables assigned to the circuit components such as environmental, operational or process parameters, computes a first solution for the characteristic variables using a statistical analysis, and then computes a second solution for the characteristic variables using an evolutionary analysis seeded by the first solution. In the exemplary implementation the statistical analysis is a central composite design (CCD) and the evolutionary analysis is a genetic algorithm. Best case and worst case CCD solutions may be used to seed separate genetic algorithm runs and derive global best case and global worst case solutions. These solutions may be compared for sensitivity analysis. The method thereby provides significant reduction in time-to-solution with accurate simulation results.

### BACKGROUND OF THE INVENTION

1. Field of the Invention

The present invention generally relates to models for simulating complex systems, and more particularly to a method of optimizing the electrical operation of an integrated circuit design.

2. Description of the Related Art

Integrated circuits are used for a wide variety of electronic applications, from simple devices such as wristwatches, to the most complex computer systems. A microelectronic integrated circuit (IC) chip can generally be thought of as a collection of logic cells with electrical interconnections between the cells, formed on a semiconductor substrate (e.g., silicon). An IC may include a very large number of cells and require complicated connections between the cells. A cell is a group of one or more circuit elements such as transistors, capacitors, resistors, inductors, and other basic circuit elements grouped to perform a logic function. Cell types include, for example, core cells, scan cells, memory cells and input/output (I/O) cells. Each of the cells of an IC may have one or more pins, each of which in turn may be connected to one or more other pins of the IC by wires. The wires connecting the pins of the IC are also formed on the surface of the chip. For more complex designs, there are typically at least four distinct layers of conducting media available for routing, such as a polysilicon layer and three metal layers (metal-1, metal-2, and metal-3). The polysilicon layer and metal layers are all used for vertical and/or horizontal routing.

An IC chip is fabricated by first conceiving the logical circuit description, and then converting that logical description into a physical description, or geometric layout. This process is usually carried out using a netlist, which is a record of all of the nets, or interconnections, between the cell pins. A layout typically consists of a set of planar geometric shapes in several layers. The layout is then checked to ensure that it meets all of the design requirements, particularly timing requirements. The result is a set of design files in an intermediate form that describe the layout. The design files are then converted into pattern generator files that are used to produce patterns called masks by an optical or electron beam pattern generator. During fabrication, these masks are used to pattern a silicon wafer using a sequence of photolithographic steps. The process of converting the specifications of an electrical circuit into a layout is called the physical design.

Due to the large number of components and the details required by the fabrication process for very large scale integrated (VLSI) devices, physical design is not practical without the aid of computers. As a result, most phases of physical design extensively use computer-aided design (CAD) tools, and many phases have already been partially or fully automated. Automation of the physical design process has increased the level of integration, reduced turn around time and enhanced chip performance. Several different programming languages have been created for electronic design automation (EDA), including Verilog, VHDL and TDML. A typical EDA system receives one or more high level behavioral descriptions of an IC device, and translates this high level design language description into netlists of various levels of abstraction.

Physical synthesis is prominent in the automated design of integrated circuits such as high performance processors and application specific integrated circuits (ASTCs). Physical synthesis is the process of concurrently optimizing placement, timing, power consumption, crosstalk effects and the like in an integrated circuit design. This comprehensive approach helps to eliminate iterations between circuit analysis and place-and-route. Physical synthesis has the ability to repower gates (changing their sizes), insert repeaters (buffers or inverters), clone gates or other combinational logic, etc., so the area of logic in the design remains fluid. However, physical synthesis can take days to complete, and the computational requirements are growing as design spaces are exponentially increasing and more gates need to be placed.

Circuit simulation is an essential part of physical synthesis. As process technology scales to the nanometer regime, it is becoming increasingly important for the performance and reliability of IC chips and systems to understand how variations in factors such as temperature, voltage, and process parameters affect the operation of an electronic device or circuit. A designer needs to model device characteristics for an extremely high number of environmental, operational and manufacturing variables. One traditional approach to circuit simulation is known as Monte Carlo. Monte Carlo methods generally refer to a class of computational algorithms that use repeated random (or pseudo-random) sampling to compute their results. However, because of this reliance on random inputs, Monte Carlo methods require a huge number of simulations in order to achieve a meaningful outcome distribution with a high confidence level, and thus become infeasible when dealing with particularly complex systems.

A variety of statistical approaches have also been employed for circuit simulation, including orthogonal arrays, design of experiments, and central composite design. Central composite design (CCD) may be used to locate sampling points within the design space. The sampling points may be set at different levels for each input variable. A typical CCD consists of three distinct sets of experimental runs: a set of center point experimental runs wherein the values of each factor are median values; a set of axial point experimental runs similar to the center point runs except for one factor which is set to values both below and above the median for that factor; and factorial point experimental runs wherein the factors are set to factorial (or fractional) values. The outputs obtained for different sampling points are then used in regression analysis to fit a response surface that is an approximation function for the system (typically a quadratic polynomial). Statistical approaches such as CCD help to reduce the number of required simulations by using a smaller set of representative solutions but these techniques make assumptions about the design space, particularly its linearity, so important outcomes can easily be overlooked.

Another approach to system-level (and circuit-level) simulation employs evolutionary computation, such as genetic algorithms. A genetic algorithm is an adaptive, heuristic exploration technique loosely based on the evolutionary principle of natural selection. A population of representations for candidate solutions to an optimization problem (an array of bits) evolves by means of variation-inducing operators such as mutation and recombination (crossover). Each candidate solution is evaluated based on a fitness function. A newly formed population then becomes the starting solution for the next iteration of the algorithm. Genetic algorithms have wide application in diverse fields including science, engineering, economics, entertainment, and electrical systems. While genetic algorithms work equally well in either a linear or nonlinear space and are not as restrictive as statistical analysis, genetic algorithms often focus on solutions that yield a desired local result without ever reaching a global optimum solution. Also if the initial value set is particularly bad (unfit) then the genetic algorithm may require an unacceptable number of iterations before it converges to a sufficiently valid result.

Circuit designers make assumptions about variations in environmental and process parameters which have a significant impact on product performance, but there is no technique for verifying these assumptions which is both reliable and efficient for very large and complex systems. If the operation of a circuit cannot be simulated with sufficient accuracy, designers must use excessive tolerances, and it becomes more difficult to evaluate any negative impact oil design rule recommendations. It would, therefore, be desirable to devise an improved method of circuit simulation which could be used to efficiently optimize a VLSI circuit design while maintaining a high confidence level in the results. It would be further advantageous if the method could retain the benefits of approaches such as statistical analysis and evolutionary computing while ameliorating their disadvantages.

### SUMMARY OF THE INVENTION

It is therefore one object of the present invention to provide an improved method for simulating complex systems, particularly very large scale integrated circuits.

It is another object of the present invention to provide such a method which yields results that accurately represent operation of the system.

It is yet another object of the present invention to provide such a method which is computationally efficient.

The foregoing objects are achieved in an automated method of optimizing an integrated circuit design by receiving a circuit description for the integrated circuit design which includes interconnected circuit components and characteristic variables assigned to the circuit components such as one or more environmental, operational or process parameters, computing a first solution for the characteristic variables using a statistical analysis, and computing a second solution for the characteristic variables using an evolutionary analysis seeded by the first solution. In the exemplary implementation the statistical analysis is a central composite design (CCD) and the evolutionary analysis is a genetic algorithm. Best case and worst case CCD solutions may be used to seed separate genetic algorithm runs and derive global best case and global worst case solutions. These solutions may be compared for sensitivity analysis.

The above as well as additional objectives, features, and advantages of the present invention will become apparent in the following detailed written description.

### BRIEF DESCRIPTION OF THE DRAWINGS

The present invention may be better understood, and its numerous objects, features, and advantages made apparent to those skilled in the art by referencing the accompanying drawings.

FIG. 1 is a block diagram of a computer system programmed to carry out computer-aided design and simulation of an integrated circuit in accordance with one implementation of the present invention;

FIG. 2 is a chart illustrating the logical flow for system simulation using a statistical analysis solution which seeds an evolutionary analysis in accordance with a generalized implementation of the present invention;

FIG. 3 is a chart illustrating the logical flow for circuit simulation and analysis using central composite design solutions which seed a genetic algorithm to produce best and worst case global solutions in accordance with one specific implementation of the present invention;

FIG. 4 is a schematic diagram of a memory subsystem circuit having multiple storage cells which may be simulated using the method of the present invention;

FIG. 5 is a pictorial representation of a system model corresponding to the memory subsystem circuit of FIG. 4 with different electrical variables assigned to components of the circuit; and

FIG. 6 is a chart illustrating the progression for simulation and analysis of the system model of FIG. 5 is wherein a very large number of possible solutions are narrowed down to a manageable number of statistical solutions which are then used in evolutionary analysis to derive best and worst case global solutions.

The use of the same reference symbols in different drawings indicates similar or identical items.

### DESCRIPTION OF THE PREFERRED EMBODIMENT(S)

The present invention is directed to an automated method for optimizing complex systems, particularly very large scale integrated (VLSI) circuits, which possesses the computational efficiencies of statistical analysis and the optimization benefits of evolutionary computing but avoids the pitfalls of these two approaches. Statistical analysis can easily miss nonlinearities in the design space because of the faulty assumption that sampling points will be representative of the global space. Evolutionary computation works well in a local space as it focuses in on a desired result but can be extremely inefficient in finding a global solution, particularly with a bad initial population set. The invention overcomes these deficiencies by using results of statistical analysis to seed (or prime) the evolutionary analysis as explained in further detail below. The method of the present invention thereby provides significant reduction of time-to-solution for a variety of complex systems, including electrical circuit design.

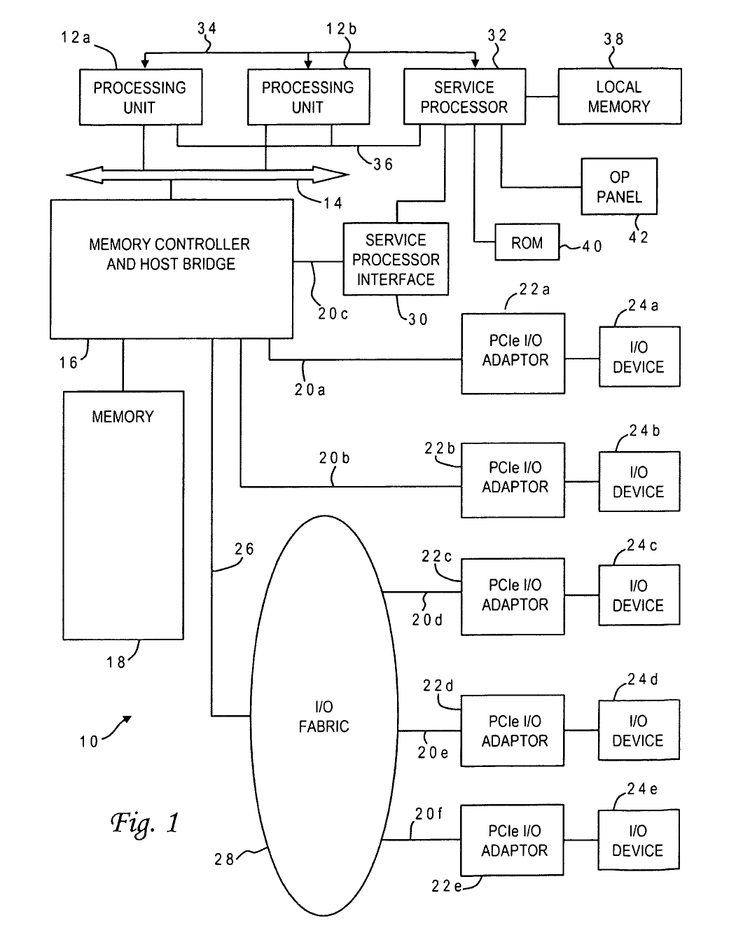

With reference now to the figures, and in particular with reference to FIG. 1, there is depicted one embodiment 10 of a computer system in which the present invention may be implemented to carry out the simulation and analysis of an integrated circuit design. Computer system 10 is a symmetric multiprocessor (SMP) system having a plurality of processors 12a, 12b connected to a system bus 14. System bus 14 is further connected to a combined memory controller/host bridge (MC/HB) 16 which provides an interface to system memory 18. System memory 18 may be a local memory device or alternatively may include a plurality of distributed memory devices, preferably dynamic random-access memory (DRAM). There may be additional structures in the memory hierarchy which are not depicted, such as on-board (L1) and second-level (L2) or third-level (L3) caches.

MC/HB 16 also has an interface to peripheral component interconnect (PCI) Express links 20a, 20b, 20c. Each PCI Express (PCIe)link 20a, 20b is connected to a respective PCIe adaptor 22a, 22b, and each PCIe adaptor 22a, 22b is connected to a respective input/output (I/O) device 24a, 24b. MC/HB 16 may additionally have an interface to an I/O bus 26 which is connected to a switch (I/O fabric) 28. Switch 28 provides a fan-out for the I/O bus to a plurality of PCI links 20d, 20e, 20f. These PCI links are connected to more PCIe adaptors 22c, 22d, 22e which in turn support more I/O devices 24c, 24d, 24e. The I/O devices may include, without limitation, a keyboard, a graphical pointing device (mouse), a microphone, a display device, speakers, a permanent storage device (hard disk drive) or an array of such storage devices, an optical disk drive, and a network card. Each PCIe adaptor provides an interface between the PCI link and the respective I/O device. MC/HB 16 provides a low latency path through which processors 12a, 12b may access PCI devices mapped anywhere within bus memory or I/O address spaces. MC/HB 16 further provides a high bandwidth path to allow the PCI devices to access memory 18. Switch 28 may provide peer-to-peer communications between different endpoints and this data traffic does not need to be forwarded to MC/HB 16 if it does not involve cache-coherent memory transfers. Switch 28 is shown as a separate logical component but it could be integrated into MC/HB 16.

In this embodiment, PCI link 20c connects MC/HB 16 to a service processor interface 30 to allow communications between I/O device 24a and a service processor 32. Service processor 32 is connected to processors 12a, 12b via a JTAG interface 34, and uses an attention line 36 which interrupts the operation of processors 12a, 12b. Service processor 32 may have its own local memory 38, and is connected to read-only memory (ROM) 40 which stores various program instructions for system startup. Service processor 32 may also have access to a hardware operator panel 42 to provide system status and diagnostic information.

In alternative embodiments computer system 10 may include modifications of these hardware components or their interconnections, or additional components, so the depicted example should not be construed as implying any architectural limitations with respect to the present invention.

When computer system 10 is initially powered up, service processor 32 uses JTAG interface 34 to interrogate the system (host) processors 12a, 12b and MC/HB 16. After completing the interrogation, service processor 32 acquires an inventory and topology for computer system 10. Service processor 32 then executes various tests such as built-in-self-tests (BISTs), basic assurance tests (BATs), and memory tests on the components of computer system 10. Any error information for failures detected during the testing is reported by service processor 32 to operator panel 42. If a valid configuration of system resources is still possible after taking out any components found to be faulty during the testing then computer system 10 is allowed to proceed. Executable code is loaded into memory 18 and service processor 32 releases host processors 12a, 12b for execution of the program code, e.g., an operating system (OS) which is used to launch applications and in particular the circuit simulation application of the present invention, results of which may be stored in a hard disk drive of the system (an I/O device 24). While host processors 12a, 12b are executing program code, service processor 32 may enter a mode of monitoring and reporting any operating parameters or errors, such as the cooling fan speed and operation, thermal sensors, power supply regulators, and recoverable and non-recoverable errors reported by any of processors 12a, 12b, memory 18, and MC/HB 16. Service processor 32 may take further action based on the type of errors or defined thresholds.

While the illustrative implementation provides program instructions embodying the present invention on disk drive 36, those skilled in the art will appreciate that the invention can be embodied in a program product utilizing other computer-readable media. The program instructions may be written in the C++ programming language for an AIX environment. Computer system 10 carries out program instructions For a novel simulation process but may additionally include design and analysis functions. Accordingly, a program embodying the invention may include conventional aspects of various circuit design and analysis tools, and these details will become apparent to those skilled in the art upon reference to this disclosure.

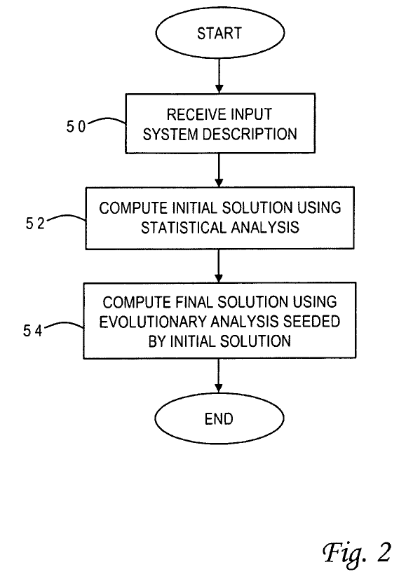

Referring now to FIG. 2, there is depicted a chart illustrating the logical flow for a generalized implementation of the present invention. The simulation process begins with an input system description (50). The nature of the system description depends upon the particular system being simulated. While the present invention is well-suited for simulating the operation of an integrated circuit design, it has wider application to a variety of complex systems including but not limited to physical systems, chemical systems, mechanical systems, biological systems, business systems, electrical systems and optical systems. The system description preferably takes the form of an array (or vector) of bits. Each related component of the system has one or more factors or characteristic variables, and each variable is represented by one or more bits in the array. The settings of the bits correspond to different values that may be assigned to the component characteristics within the confines of the design space. Statistical analysis is first performed to compute one or more initial solutions (52). For example, central composite design (CCD) may be used to generate a small number of representative system solutions (vectors). An initial solution from the statistical analysis is then used as an input to evolutionary analysis which computes a final optimized solution (54). For example, a CCD bit vector may be used to seed a genetic algorithm. The final step may be repeated using different initial solutions from the statistical analysis to derive multiple final solutions.

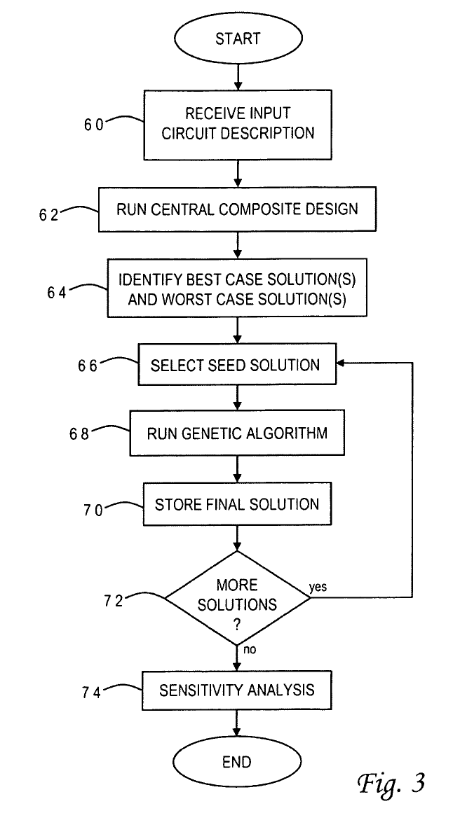

A more specific implementation of the present invention for simulating and analyzing an integrated circuit design is described with reference to FIG. 3. The automated process begins when the computer system receives an input circuit description (60). The input circuit description is based on a netlist of connections between various components of the circuit, and each circuit component is represented by one or more characteristic variables in the circuit description according to the simulation parameters selected by the designer. The variables may include but are not limited to ambient temperature, applied voltage, and process parameters such as impedance or dielectric thickness. The simulation model may assign binary values (±1) to each factor, or may provided higher setting levels with multiple bits using binary encoding.

The circuit design is then subjected to central composite design to yield a plurality of representative solutions (62). The invention is not limited to any particular central composite design method, e.g., circumscribed or inscribed, but preferably utilizes face-centered CCD. Each vector in the CCD array represents one simulation wherein values for each factor have been set. The representative solutions are examined to identify one or more best case solutions and one or more worst case solutions according to a known optimization function established by the designer (64). The function may for example be a voltage gain function. The designer may set threshold fitness values (minimum and maximum gain) to identify solutions as being a best case or a worst case, or the process may alternatively pick a predetermined number of solutions with the most extreme fitness values, e.g., the three best cases and the three worst cases.

Any one of these best/worst case CCD solutions is then selected for further processing (66), and is used as an input solution to a genetic algorithm (68). The invention is not limited to any particular genetic algorithm although it employs a fitness function similar to the function that was used to identify best and worst cases from the CCD output. Commercially available genetic algorithms may be used such the “OptimizePI” design tool marketed by Sigrity, Inc. of Santa Clara, Calif. Preferably an elitism-enforced genetic algorithm is used. The genetic algorithm repeats iteratively until a termination criterion is met (e.g., computation time limit or fitness threshold) to yield a final solution which is stored for later analysis (70). If there are still more CCD solutions to analyze (72), the process repeats at step 66 by selecting the next CCD solution to seed the genetic algorithm population. Once all final solutions have been computed and stored, they are used for sensitivity analysis to determine which component characteristics have the greatest impact on performance (74).

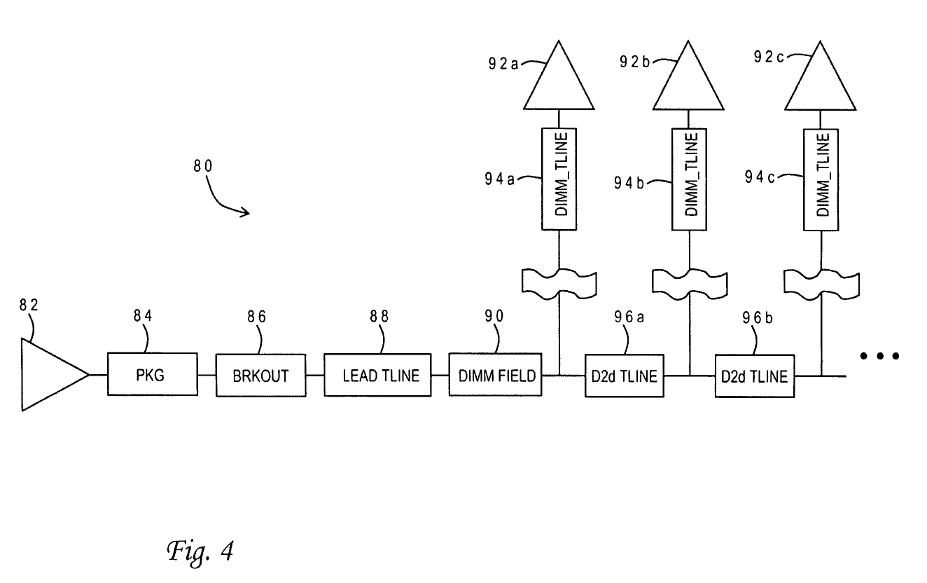

This process may be further understood with reference to the exemplary circuit design 80 schematically illustrated in FIG. 4. Circuit design 80 is a double-data rate (DDR) memory subsystem whose write (store) cycle is to be modeled and analyzed. The DDR memory subsystem includes an input voltage source 82 (from a memory controller), a package 84 interconnected with voltage source 82, a breakout line 86 connected to package 84, a lead transmission line 88 connected to breakout line 86, a dual-inline memory module (DIMM) field line 90 connected to lead transmission line 88, and several storage cells 92a, 92b, 92c which are connected via DIMM transmission lines 94a, 94b, 94c to either DIMM field line 90 or to DIMM-to-DIMM transmission lines 96a, 96b. Although only three are shown, the DDR memory subsystem may have hundreds of storage cells 92.

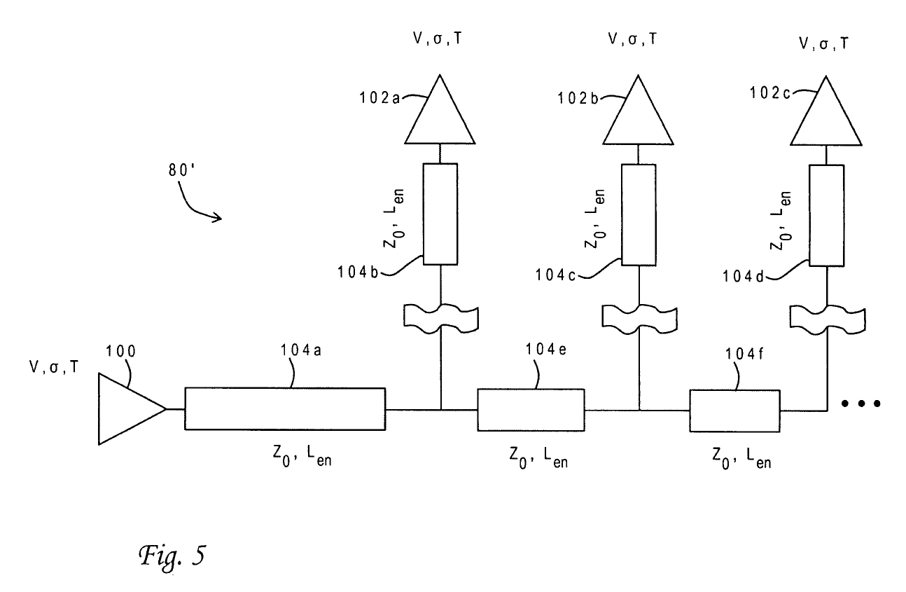

Circuit design 80 may be transformed into the model 80′ shown in FIG. 5. Model 80′ represents a problem description for the DDR memory subsystem. Most integrated circuit designs can be thought of as a driver connected to one or more channels which are further connected to one or more receivers. Characteristic variables can be assigned to each of these model components. In this example input voltage source 82 corresponds to a driver 100, the storage cells 92a, 92b, 92c correspond to receivers 102a, 102b, 102c, and these components are affected by operational voltage (V), process variation (σ), and temperature (T) variables. Package 84, breakout line 86, lead transmission line 88 and DIMM field line 90 are consolidated into a single channel 104a, DIMM transmission lines 94a, 94b, 94c and DIMM-to-DIMM transmission lines 96a, 96b are modeled as separate channels 104b, 104c, 104d, 104e, 104f, and all of these channels are assigned impedance (Z₀) and length (L_{cn}) variables. Additional receivers and channels are similarly modeled for the remaining storage cells in the DDR memory subsystem. The parameters to be varied may for example include bit-pattern setting, package/breakout/lead transmission line impedance, DIMM transmission line impedance, and DIMM-to-DIMM transmission line impedance.

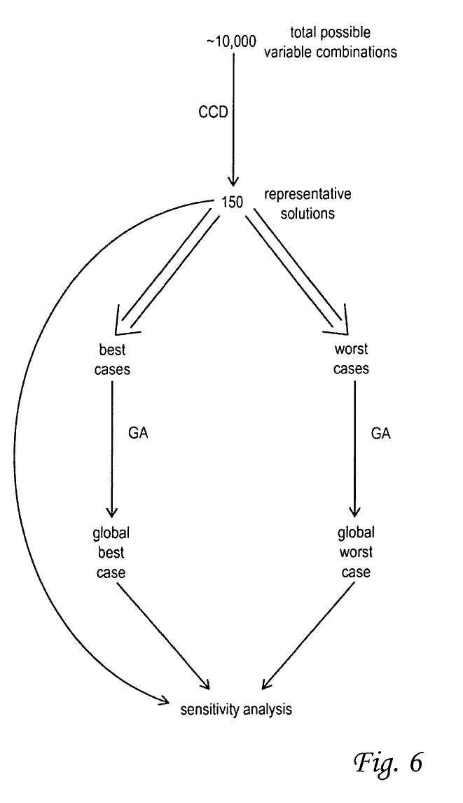

Depending on the number of variables and the possible settings there can easily be 10,000 or more total variable combinations for a relatively small DDR memory subsystem. As seen in FIG. 6, these 10,000 or so possible combinations are reduced by CCD or other statistical analysis to a much smaller number of representative solutions, for example 150. The two or three best cases are selected from these 150 representative solutions and are used to seed the genetic algorithm or other evolutionary computation and yield a global best case, and the two or three worst cases from these 150 representative solutions are similarly used to yield a global worst case. The global worst case solution is used by the designer to ensure that minimum requirements are met, while the best case solution is used to control variations and produce a superior product.

The global best and worst cases may be compared against each other and with the 150 CCD solutions for sensitivity analysis. A conventional sensitivity analysis tool may be used, such as ANOVA (Analysis of Variance) which is available in a wide variety of commercial forms including the Analysis ToolPak in the Excel spreadsheet program marketed by Microsoft Corp. of Redmond, Wash. The sensitivity analysis determines which variable perturbation results in the most significant change, and allows the designer to better evaluate the potential impact of design rule recommendations. For example, sensitivity analysis performed on the simulation results for the DDR memory subsystem modeled in FIG. 5 indicates that the lead transmission line characteristics are more sensitive than other model parameters.

The method of the present invention thereby provides significant reduction of time-to-solution for a variety of complex systems, including VLSI integrated circuits. This time reduction is even greater as the problem size increases. The designer is able to efficiently obtain accurate best and worst cases with fewer number of simulations. Sensitivity analysis along with obtaining best and worst case corners with fewer number of simulations help designers to more efficiently optimize complex system designs.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. For example, other statistical analysis techniques may be used to seed the evolution computation besides CCD, such as orthogonal arrays or design of experiment. Similarly, other evolutionary computation techniques can be used Such as neural networking, evolutionary programming, or genetic programming. The invention furthermore has wide application to a diverse range of system models other than electrical circuits. It is therefore contemplated that such modifications can be made without departing from the spirit or scope of the present invention as defined in the appended claims.

What is claimed is:

1. An automated method of optimizing a system design, comprising:
receiving a description for the system design which includes a plurality of related system components and characteristic variables assigned to the system components;
computing at least a first solution for the characteristic variables using a statistical analysis; and
computing at least a second solution for the characteristic variables using an evolutionary analysis seeded by the first solution.

2. The method of claim 1 wherein the statistical analysis is a central composite design.

3. The method of claim 1 wherein the evolutionary analysis is a genetic algorithm.

4. The method of claim 1 wherein the system design is an integrated circuit design and the characteristic variables including one or more environmental, operational or process parameters.

5. The method of claim 1, further comprising carrying out sensitivity analysis by comparing the second solution to the first solution.

6. An automated method of optimizing an integrated circuit design, comprising:
receiving a circuit description for the integrated circuit design which includes a plurality of interconnected circuit components and characteristic variables assigned to the circuit components, the characteristic variables including one or more environmental, operational or process parameters;
computing at least a first solution for the characteristic variables using a statistical analysis; and
computing at least a second solution for the characteristic variables using an evolutionary analysis seeded by the first solution.

7. The method of claim 6 wherein the statistical analysis is a central composite design.

8. The method of claim 6 wherein the evolutionary analysis is a genetic algorithm.

9. The method of claim 6 wherein the first solution is a best case statistical solution and the second solution is a global best case solution, and further comprising:
computing a worst case statistical solution for the characteristic variables using the statistical analysis; and
computing a global worst case solution for the characteristic variables using the evolutionary analysis seeded by the worst case statistical solution.

10. The method of claim 9, further comprising carrying out sensitivity analysis by comparing the global best case solution and global worst case solution to the best case statistical solution and the worst case statistical solution.

11. A computer system comprising:
one or more processors which process program instructions;
a memory device connected to said one or more processors; and
program instructions residing in said memory device for optimizing an integrated circuit design by receiving a circuit description for the integrated circuit design which includes a plurality of interconnected circuit components and characteristic variables assigned to the circuit components, the characteristic variables including one or more environmental, operational or process parameters, computing at least a first solution for the characteristic variables using a statistical analysis, and computing at least a second solution for the characteristic variables using an evolutionary analysis seeded by the first solution.

12. The computer system of claim 11 wherein the statistical analysis is a central composite design.

13. The computer system of claim 11 wherein the evolutionary analysis is a genetic algorithm.

14. The computer system of claim 11 wherein the first solution is a best case statistical solution and the second solution is a global best case solution, and further comprising:
computing a worst case statistical solution for the characteristic variables using the statistical analysis; and
computing a global worst case solution for the characteristic variables using the evolutionary analysis seeded by the worst case statistical solution.

15. The computer system of claim 14 wherein the program instructions further carry out sensitivity analysis by comparing the global best case solution and global worst case solution to the best case statistical solution and the worst case statistical solution.

16. A computer program product comprising:
a computer-readable medium; and
program instructions residing in said medium for optimizing an integrated circuit design by receiving a circuit description for the integrated circuit design which includes a plurality of interconnected circuit components and characteristic variables assigned to the circuit components, the characteristic variables including one or more environmental, operational or process parameters, computing at least a first solution for the characteristic variables using a statistical analysis, and computing at least a second solution for the characteristic variables using an evolutionary analysis seeded by the first solution.

17. The computer program product of claim 16 wherein the statistical analysis is a central composite design.

18. The computer program product of claim 16 wherein the evolutionary analysis is a genetic algorithm.

19. The computer program product of claim 16 wherein the first solution is a best case statistical solution and the second solution is a global best case solution, and further comprising:
computing a worst case statistical solution for the characteristic variables using the statistical analysis; and
computing a global worst case solution for the characteristic variables using the evolutionary analysis seeded by the worst case statistical solution.

20. The computer program product of claim 19 wherein the program instructions further carry out sensitivity analysis by comparing the global best case solution and global worst case solution to the best case statistical solution and the worst case statistical solution.
